(19) United States
(12) Patent Application Publication
(10) Pub. No.: US 2018/0309466 A1
(43) Pub. Date: Oct. 25, 2018

(54) A MULTIPLEXER WITH SWITCHABLE FILTER

(71) Applicant: THOMSON Licensing, Issy-les-Moulineaux (FR)

(72) Inventor: Paul G. KNUTSON, WESTFIELD, IN (US)

(21) Appl. No.: 15/768,081

(22) PCT Filed: Oct. 14, 2015
(86) PCT No.: PCT/US2015/055459

§ 371 Date: Apr. 13, 2018

(51) Int. Cl. H04B 1/16

(52) U.S. Cl. CPC H04B 1/16; H04L 12/2892

(57) ABSTRACT

A diplexer filter having an upstream port, a downstream port and a Cable connector port forms a first transfer function for a first radio frequency (RF) signal that is coupled from the upstream port to the Cable connector port and a second transfer function for a second RF signal that is coupled from the Cable connector port to the downstream port. It includes a first filter (F1) when the first transfer function is applied and a second filter (F2) when the first transfer function is applied. A third filter (F3) coupled via a switch for selectively coupling said third filter to combine a transfer function of the third port with a transfer function of the first filter, when the Data Over Cable Service Interface Specification (DOCSIS) 3.1 is selected, and for selectively coupling the third filter to combine the transfer function of the third filter with a transfer function of the second filter, when the DOCSIS 3.0 is selected.

### FIELD OF THE DISCLOSURE

The disclosure relates to a filter for filtering a radio frequency (RF) signal.

### BACKGROUND

In the cable network example, the cable head end typically provides input signals to, for example, a set-top box. A multiplexing filter forms an input/output stage of the set-top box. The input signals, applied via a transmission line, may contain, for example, television signals.

FIG. 1a illustrates schematically a range of frequencies, from 5 MHz to 42 MHz, of a radio frequency (RF) signal that is applied via the set-top box transmission line. The RF signal of FIG. 1a conforms to a so-called, Data Over Cable Service Interface Specification (DOCSIS) 3.0 which is what is returned from a subscriber site, for example, a home back to the cable operator's headend, referred to an Upstream (US) path. FIG. 1b illustrates schematically a range of frequencies, from 55 MHz and higher, of an RF signal that is applied via the set-top box transmission line. The RF signal of FIG. 1b conforms to DOCSIS 3.0 and is applied from the cable operator's headend to the subscriber site, referred to a Downstream (DS) path.

FIG. 1c illustrates schematically a range of frequencies, from 5 MHz to 85 MHz for an RF signal conforming to DOCSIS 3.1 that is applied via the US path. FIG. 1d illustrates schematically a range of frequencies, from 108 MHz and higher for an RF signal conforming to DOCSIS 3.1 that is applied via the DS path.

It may be desirable to have a cable modem at the subscriber site which can selectively filter each frequency range of FIGS. 1a-1d at each of the DOCSIS 3.1 and DOCSIS 3.0. A typical solution for such requirement would be to have two separate filters, one conforming to the DOCSIS 3.1 and the other one to DOCSIS 3.0. When DOCSIS 3.1 is selected, the DOCSIS 3.1 filter elements are utilized and none of the filter elements associated with DOCSIS 3.0 is utilized. On the other hand, when DOCSIS 3.0 is selected, the DOCSIS 3.0 filter elements are utilized and none of the elements of the DOCSIS 3.1 filter is utilized. Disadvantageously, such complete duplication may increase cost. It also, disadvantageously, might require using semiconductor switches that can introduce harmonics at the cable connector. Avoiding such harmonics is an important restriction that is required by the cable service provider.

### SUMMARY

In accordance with an aspect of the disclosure, a multiplexing filter having a first port, a second port and a third port is provided. A first filter is coupled to the first and third ports for applying a first transfer function to a first radio frequency (RF) signal, when coupled via the first filter from the first port to the third port. A second filter is coupled to the second and third ports for applying a second transfer function to a second RF signal, when coupled via the second filter from the third port to the second port. A switch responsive to a control signal that is indicative when a first mode is selected and when a second mode is selected is provided. A third filter is coupled to the third port, when each of the first and second modes is selected. The third filter is selectively coupled by the switch to the first port, when the first mode is selected, and to the second port, when the second mode is selected.

In accordance with another aspect of the disclosure, a selectable filter having a first port and a second port is provided. A switch is responsive to a control signal. A first filter is coupled to the first and second ports for providing a first transfer function, when the switch is at a first state. A second filter is coupled to the second port and selectively coupled to the first port by an operation of the switch, when the switch is at the second state, for combining a second transfer function of the second filter and the first transfer function of the first filter to form a combined, third transfer function. The second transfer function has a second roll off region and the first transfer function has a first roll off region that, at least partially, overlap each other in a manner to extend a frequency range of the combined, third transfer function beyond a frequency range of the first transfer function, alone.

### BRIEF DESCRIPTION OF THE DRAWINGS

The preferred embodiment of the present arrangement will be described below in more detail with reference to the accompanying drawings in which:

FIGS. 1a and 1b illustrate Upstream and Downstream frequency ranges, respectively, representative of DOCSIS 3.0;

FIGS. 1c and 1d illustrate the Upstream and Downstream frequency ranges, respectively, representative of DOCSIS 3.1;

FIGS. 1e, 1f and 1g illustrate schematically the transfer functions of stand-alone filters F1, F2 and F3, respectively, of FIG. 2, in accordance with an advantageous embodiment,

FIG. 2 illustrates in a block diagram a diplexer, embodying an advantageous feature, for use in a set-top box modem, that includes filters F1, F2 and F3;

FIGS. 3a, 3b and 3c illustrate detailed schematic diagrams of filters F1, F2 and F3, respectively, of FIG. 2;

FIG. 4 illustrates a graph obtained by simulation representing an input return loss from an input cable connector of combined filters F1, F2 and F3 of FIGS. 3a, 3b and 3c, respectively;

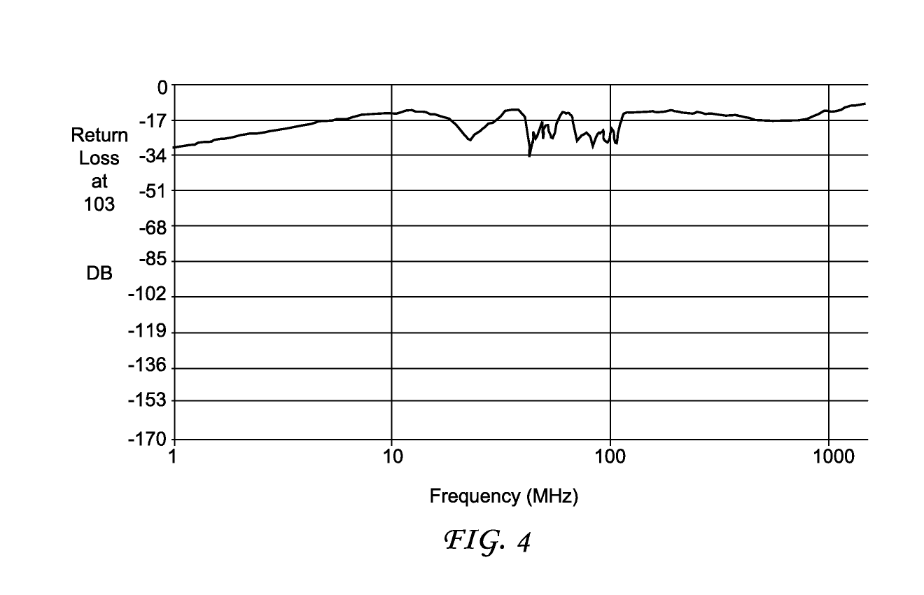

FIG. 5 illustrates a graph obtained by simulation representing the transfer function from an input cable connector to a Downstream port of the combination of filters F2 and F3 of FIGS. 3b and 3c, respectively; and

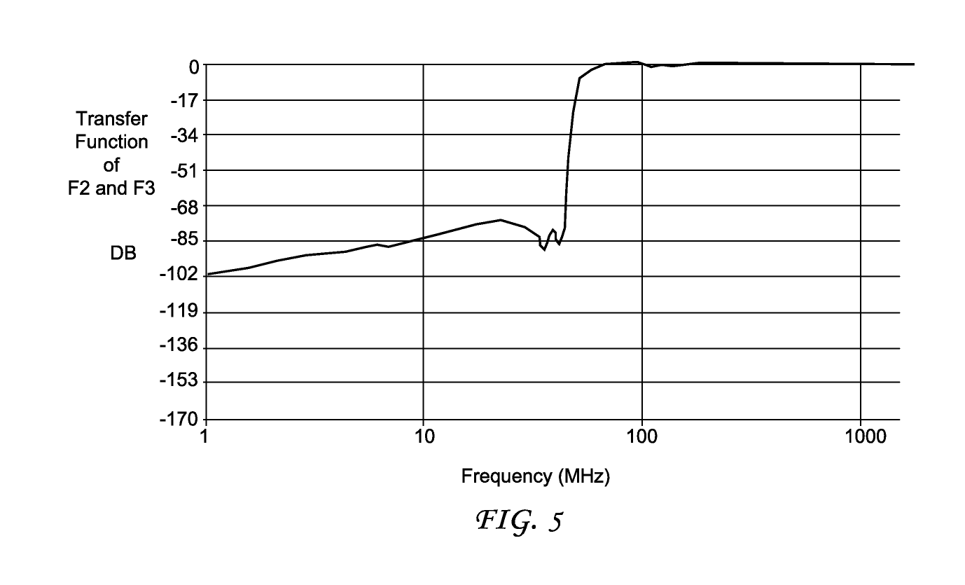

FIG. 6 illustrates a graph obtained by simulation representing the transfer function from an Upstream port to an input cable connector of the combination of filters F1 and F3 of FIGS. 3a and 3c, respectively.

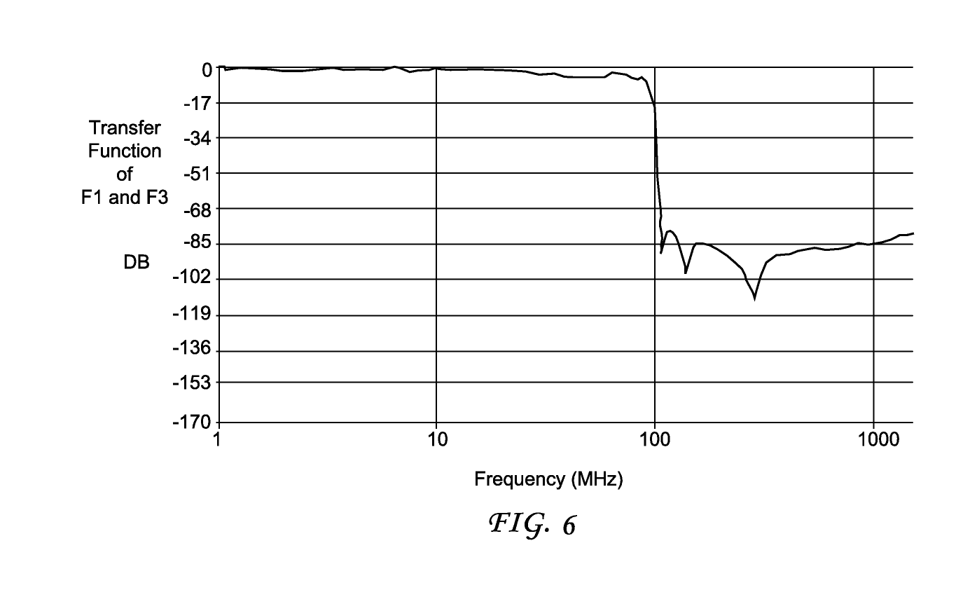

### DETAILED DESCRIPTION

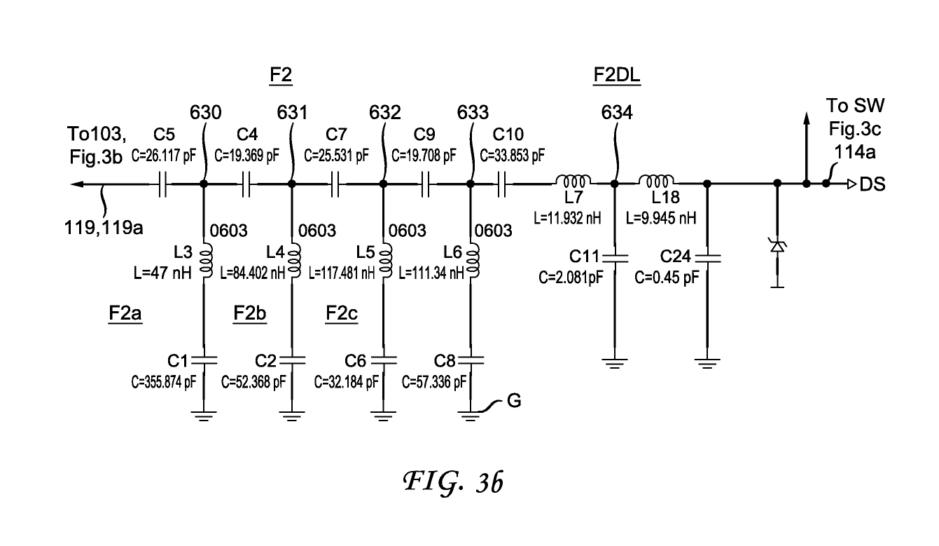

FIG. 2 illustrates a block diagram of a multiplexer or, more specifically, a diplexer 100, embodying an advantageous feature that is included in a cable modem of a set-top box, not shown in details. Diplexer 100 is coupled, in operation, to a cable service provider 101 via an input/output cable connector 103 of diplexer 100 and via a transmission line cable 112.

Diplexer 100 has a so-called Downstream output port DS forming an input port of a radio frequency (RF) signal receiver 114. RF signal receiver 114 selectively conforms either to a so-called Data Over Cable Service Interface Specification (DOCSIS) 3.0 or to a so-called DOCSIS 3.1. RF receiver 114 is selectable, in a manner not shown. However, the operation of RF receiver 114 when selectively conforming either to DOCSIS 3.0 or to DOCSIS 3.1 is conventional. Diplexer 100 also has a so-called Upstream input port US that also forms an output port of a conventional RF signal transmitter 115 selectively conforming either to DOCSIS 3.0 or to DOCSIS 3.1. Similarly to receiver 114, the operation in RF signal transmitter 115 can be selectable, in a manner not shown, to conform either to DOCSIS 3.0 or to DOCSIS 3.1.

Diplexer 100 includes a delay element F1DL coupled to and concatenated with a low-pass filter F1 for filtering and delaying an RF signal 115a developed by DOCSIS transmitter 115 at Upstream port US. In operation, DOCSIS transmitter 115 produces at least a first portion of filtered and delayed RF signal 103a that is developed at input/output cable connector 103 of diplexer 100 and that is applied to cable service provider 101 via transmission line cable 112.

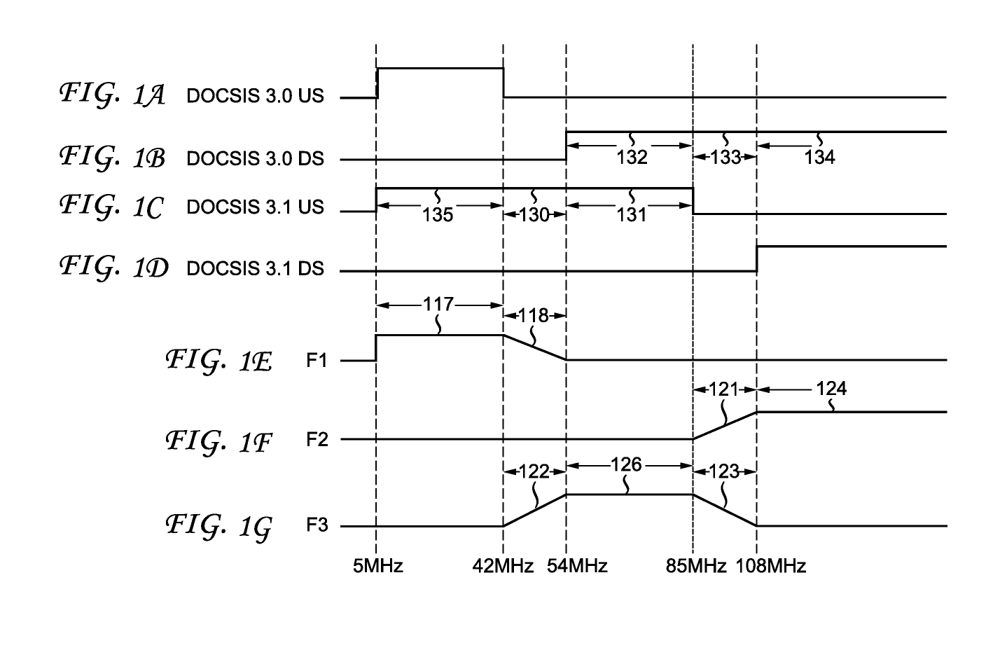

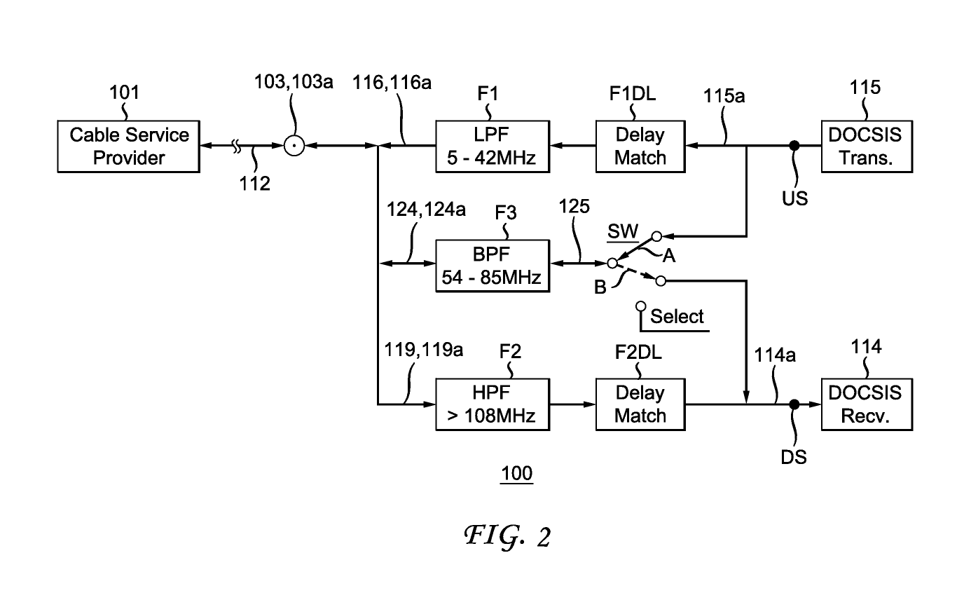

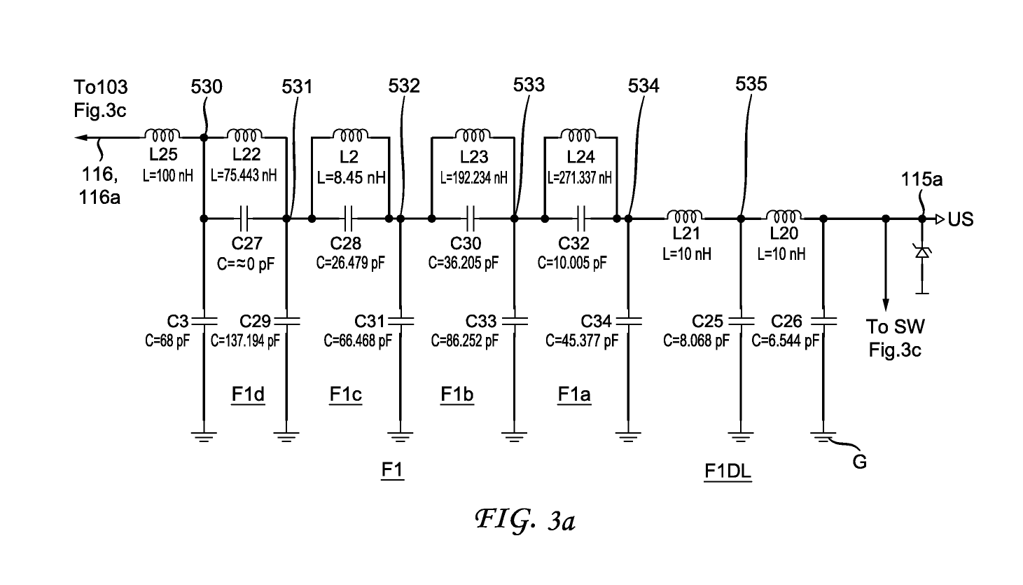

A range of frequencies that is passed or applied by stand-alone low-pass filter F1 is schematically illustrated in a simplified manner for the purpose of explanation as a transfer function of FIG. 1e. Similar symbols and numerals in FIGS. 1a-1e and 2 represent similar items or functions. The transfer function of stand-alone low-pass filter F1 of FIG. 2 includes a flat portion 117 of FIG. 1e between 5 MHz and 42 MHz in which the transfer function of stand-alone low-pass filter F1 of FIG. 2 does not change by, for example, more than 2 dB, as shown in FIG. 1e. The transfer function also includes a roll-off portion 118 that extends from 42 MHz and higher with a drop in the transfer function of filter F1 of FIG. 2 of <−70 dB at, for example, 54 MHz of FIG. 1e.

Diplexer 100 of FIG. 2 additionally includes a high-pass filter F2 coupled in series with a delay element F2DL for filtering and delaying RF signal 103a that is applied by cable service provider 101 via transmission line 112 and via cable connector 103. Filtered and delayed RF signal 103a develops a corresponding first portion of an input RF signal 114a developed at Downstream input port DS of DOCSIS receiver 114.

A range of frequencies that is passed and applied by stand-alone high-pass filter F2 is schematically illustrated in a simplified manner for the purpose of explanation as a transfer function of FIG. 1f. Similar symbols and numerals in FIGS. 1a-1f and 2 represent similar items or functions. The transfer function includes a flat portion 124 of FIG. 1f representing a range of frequencies higher than 108 MHz in which the transfer function does not change by more, for example, than 2 dB. It also includes a roll-off portion 121 that extends from 108 MHz to lower frequencies with a drop in the transfer function of stand-alone filter F2 of FIG. 2 of <−70 dB at, for example, 85 MHz of FIG. 1f.

Diplexer 100 of FIG. 2 further includes a band-pass filter F3 for filtering input RF signal 115a to develop a corresponding portion of signal 103a. This is realized by the operation of a semiconductor switch SW, shown schematically, that is controlled by a selection signal SELECT to be at a position A, when input RF signal 115a is within a frequency passing range of filter F3. Band-pass filter F3 is alternatively and selectively used for filtering RF signal 103a to produce a corresponding portion of input RF signal 114a at Downstream input port DS of DOCSIS receiver 114, when both semiconductor switch SW is controlled by selection signal SELECT to be at a position B and RF signal 103a is within a frequency passing range of filter F3.

A range of frequencies that is passed by stand-alone band-pass filter F3 at either direction is schematically illustrated in a simplified manner for the purpose of explanation as a transfer function of FIG. 1g. Similar symbols and numerals in FIGS. 1a-1g and 2 represent similar items or functions. The transfer function of stand-alone band-pass filter F3 of FIG. 2 includes a flat portion 126 of FIG. 1g between 54 MHz and 85 MHz in which the transfer function of stand-alone low-pass filter F1 of FIG. 2 does not change by, for example, more than 2 dB of FIG. 1g. The transfer function also includes a roll-off portion 123 that extends from 85 MHz and higher with a drop in the transfer function of filter F3 of FIG. 2 of <−70 dB at, for example, 108 MHz of FIG. 1g. Additionally, it includes a roll-off portion 122 that extends from 54 MHz and lower with a drop in the transfer function of filter F3 of FIG. 2 of <−70 dB at, for example, 45 MHz of FIG. 1g.

DOCSIS receiver 114 and DOCSIS transmitter 115 of FIG. 2 can operate in a simplex mode or, alternatively, in a duplex mode. Diplexer 100 is selectively controlled by switch SW to conform to either DOCSIS 3.0 or DOCSIS 3.1.

When switch SW is selected to be at position A, the Downstream frequency range or transfer function of diplexer 100 of FIG. 2 of high-pass filter F2 passes signals at frequencies above 108 MHz of signal 103a to Downstream port DS in a manner to conform to DOCSIS 3.1 of FIG. 1d. When switch SW is selected to be at position A, signal 115a at port US, within the frequency range, 5 MHz-42 MHz, of filter F1, is applied to connector 103 via a signal path formed by filter F1 to form flat transfer function 117 at a frequency range 135 of FIG. 1c. Also, when switch SW is selected to be at position A, signal 115a at port US within the frequency range, 54 MHz-85 MHz, of filter F3 is applied to connector 103 via a signal path formed by filter F3 to form flat transfer function 126 at a frequency range 131 of FIG. 1c. In addition, when switch SW is selected to be at position A and signal 115a at port US is within roll-off portion 122 of FIG. 1g of filter F3 of FIG. 2 and also within roll-off portion 118 of FIG. 1e of filter F1 of FIG. 2, corresponding portions of signal 115a are applied to connector 103 via both the signal path formed by filter F1 and the parallel signal path formed by filter F3. As a result, the portion signals of signal 115a are summed up or super-imposed in the conductor that is common to connector 103 to form flat transfer function at a frequency range 130 of FIG. 1c.

Thus, the total range of frequencies passed by the parallel signal paths is, advantageously, extended and results in a combined flat transfer function in an Upstream frequency range that conforms to DOCSIS 3.1 of FIG. 1c. Advantageously, delay match F1DL of FIG. 2, that is disposed in series with filter F1, results in matching the signal delay between signal 115a that is applied to connector 103 via the signal path that includes filter F1 and via the signal path that includes filter F3.

When switch SW is selected to be at position B, Upstream frequency range of diplexer 100 of FIG. 2 of low-pass filter F1, that passes signals at frequencies between 5 MHz and 42 MHz, applies signal 115a at Upstream port US to connector 103 in a manner to conform to DOCSIS 3.0 of FIG. 1a. When switch SW is selected to be at position B, signal 103a at connector 103, that is within the frequency range of over 108 MHz of filter F2, is applied to port DS via a signal path formed by filter F2 to form flat transfer function 124 at a frequency range 134 of FIG. 1b. Also, when switch SW is selected to be at position A, signal 103a at connector 103 within the frequency range, 54 MHz-85 MHz, of filter F3 is applied to port DS via a signal path formed by filter F3 to form flat transfer function 126 at a frequency range 132 of FIG. 1b. In addition, when switch SW is selected to be at position B and signal 103a at connector 103 is within roll-off portion 123 of FIG. 1g of filter F3 of FIG. 2 and also within roll-off portion 121 of FIG. 1f of filter F2 of FIG. 2, corresponding portions of signal 103a are applied to port DS via both the signal path formed by filter F2 and the parallel signal path formed by filter F3. As a result, the portion signals of signal 103a are summed up or super-imposed in the conductor that is common to port DS to form flat transfer function at a frequency range 133 of FIG. 1b.

Thus, the total range of frequencies passed by the parallel signal paths is, advantageously, extended and results in a combined flat transfer function in the Downstream frequency range that conforms to DOCSIS 3.0 of FIG. 1b. Advantageously, delay match F2DL of FIG. 2, that is disposed in series with filter F2, results in matching the signal delay between signal 103a that is applied to port DS via the signal path that includes filter F2 and via the signal path that includes filter F3.

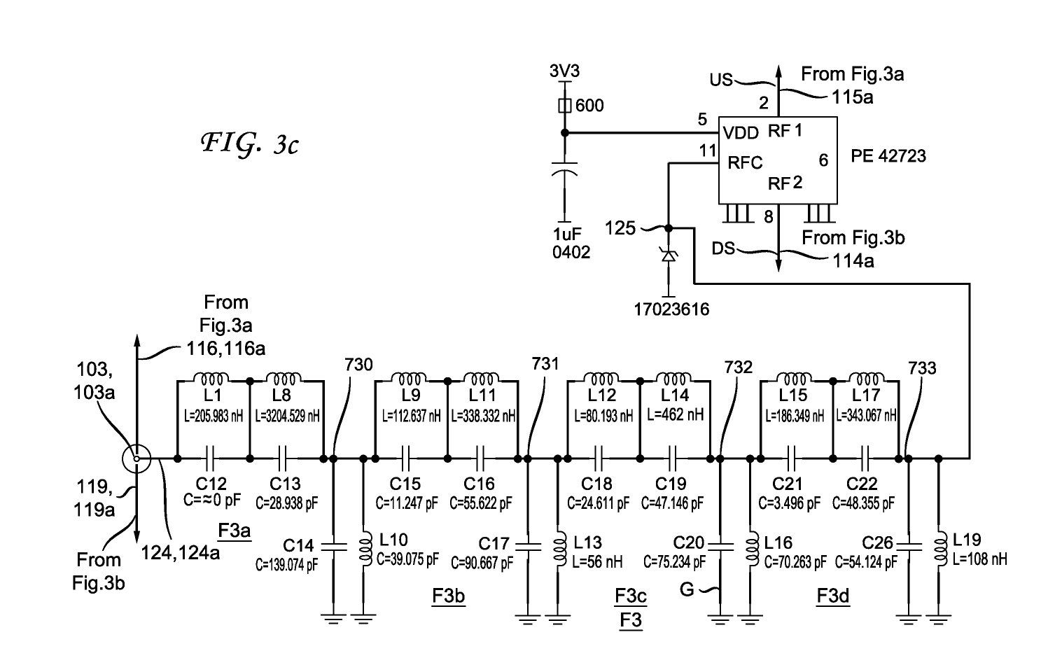

FIGS. 3a, 3b and 3c illustrate in details filters F1, F2 and F3, respectively, of diplexer 100 of FIG. 2. Similar symbols and numerals in FIGS. 1a-1f, 2 and 3a-3c represent similar items or functions.

Upstream port US of FIG. 3a is coupled via delay match F1DL that includes a capacitor C26 having a first end terminal that is common to port US and a second end terminal that is common to a ground conductor G. An inductor L20 has a first end terminal that is common to port US and a second end terminal 535. Second end terminal 535 is common with a first end terminal of a capacitor C25. A second end terminal of capacitor C25 is coupled to reference potential of ground conductor G. An inductor L21 has a first end terminal that is common to end terminal 535 and a second end terminal 534. Second end terminal 534 is common with a first end terminal of a capacitor C34. A second end terminal of capacitor C34 is at ground G. Second end terminal 534 forms, in common, an output terminal of delay match F1DL and an input terminal of filter F1.

Low-pass filter F1 includes a section F1a, a section F1b, a section F1c and a section F1d that are concatenated and have the same topology. Section F1a, for example, includes an inductor L24 and a capacitor C32 that are coupled in parallel. Each of inductor L24 and capacitor C32 has a first end terminal that is common to input junction terminal 534. Each of inductor L24 and capacitor C32 has a second terminal that is common to an output junction terminal 533. Junction terminal 533 also forms a first end terminal of a capacitor C33 having a second terminal at ground conductor G.

Similarly to section F1a, sections F1b includes an inductor L23, a capacitor C30, a capacitor C31, input terminal 533 and an output terminal 532. Section F1c includes an inductor L2, a capacitor C28, a capacitor C29, input terminal 532 and an output terminal 531. Section F1d includes an inductor L22, a capacitor C27, a capacitor C3, input terminal 531 and an output terminal 530. The aforementioned elements forming any of section F1b, F1c and F1d correspond to the elements, inductor L24, capacitor C32, capacitor C33, input terminal 534 and output terminal 533 of section F1a.

Low-pass filter F1 includes an inductor L25 having a first terminal that is common with output terminal 530 and a second that is common with connector 103 of FIG. 3c. Inductor L25 of FIG. 3a isolates filter F1 from connector 103 at high frequencies.

High-pass filter F2 of FIG. 3b includes a section F2a, a section F2b, a section F2c and a section F2d that are concatenated and have the same topology. Section F2a, for example, includes a capacitor C5 having a first end terminal that is common to input connector 103 of FIG. 3c and a second end terminal that is common to an output junction terminal 630 of FIG. 3b. It also includes an inductor L3 and a capacitor C1 that are series coupled between output junction terminals 630 and ground potential G.

Similarly, section F2b includes a capacitor C4, input terminal 630, an inductor L4, a capacitor C2 and an output terminal 631. Section F2b includes a capacitor C4, input terminal 630, an inductor L4, a capacitor C2 and an output terminal 631. Section F2c includes a capacitor C7, input terminal 631, an inductor L5, a capacitor C6 and an output terminal 632. Section F2d includes a capacitor C9, input terminal 632, an inductor L6, a capacitor C8 and an output terminal 633. The aforementioned elements forming any of section F2b, F2c and F2d correspond to the elements, capacitor C5, input connector 103 of FIG. 3a, inductor L3 of FIG. 3b, capacitor C1 and output terminal 630, respectively, of section F2a.

Terminal 633 is coupled via a capacitor C10 and delay match F2DL to Downstream terminal DS. Delay match F2DL includes an inductor L7 coupled in series with capacitor C10 that are coupled between terminal 633 and a terminal 634. A capacitor C11 has a first end terminal that is coupled to terminal 634 and a second end terminal that is common to ground conductor G. An inductor L18 has a first end terminal that is common to port DS and a second end terminal that is coupled to terminal 634. Port DS is common with a first end terminal of a capacitor C24. A second end terminal of capacitor C24 is at ground G to form delay match F2DL.

Bi-directional band-pass filter F3 of FIG. 3c includes a section F3a, a section F3b, a section F3c and a section F3d that are concatenated and have the same topology. Section F3a, for example, includes an inductor L1 coupled in parallel with a capacitor C12, an inductor L8 coupled in parallel with a capacitor C13 and an inductor L10 coupled in parallel with a capacitor C14. The parallel coupled inductor L1 and capacitor C12 is coupled in series with the parallel coupled inductor L1 and capacitor C12 to form a series coupled arrangement that is coupled between connector 103 and a terminal 730 of FIG. 3c. The parallel coupled arrangement of inductor L10 and capacitor C14 is coupled between terminal 730 and ground conductor G.

Similarly, section F3b includes an inductor L9, a capacitor C15, an inductor L11, a capacitor C16, an inductor L13, a capacitor C17, terminal 730 and a terminal 731. Section F3c includes an inductor L12, a capacitor C18, an inductor L14, a capacitor C19, an inductor L16, a capacitor C20, terminal 731 and a terminal 732. Section F3d includes an inductor L15, a capacitor C21, an inductor L17, a capacitor C22, an inductor L19, a capacitor C23, terminal 732 and a terminal 733. The aforementioned elements forming section F3b, F3c and F3d correspond to the elements, inductor L1, capacitor C12, inductor L8, capacitor C13, inductor L10, capacitor C14, connector 103 and terminal 730, respectively, of section F3a.

Terminal 733 is forms an output terminal of semiconductor switch SW. Similarly, port US of FIG. 3a form an input terminal of switch SW of FIG. 3c. Whereas, port DS of FIG. 3b forms an output terminal of switch SW of FIG. 3c.

Filter F3 of FIG. 3c is interposed between switch SW and cable connector 103. Therefore, any harmonics created by non-linearity of switch SW is, advantageously, filtered out from cable connector 103. Avoiding harmonics at cable connector 103 is an important restriction that is required by the cable service provider.

Transmission line cable 112 of FIG. 2 has a characteristic impedance of, typically, 75 Ohm. Output impedance and an input impedance of diplexer 100 at cable connector 103 are preferably the same as the characteristic impedance of, cable 112. In order to maintain the input impedance at 75 Ohm, each input impedance of filters F1, F2 and F3 is designed to increase at a frequency range that is out of the corresponding filter passband. The Genesys design software from Agilent has been used for optimizing the frequency response of each of filters F1, F2 and F3, in particular, in the roll-off transition region between two filters such as regions 118 and 122 of Filters F1 and F3, respectively.

1-12. (canceled)

13. A receiver comprising a multiplexing filter, the multiplexing filter having a first port, a second port and a third port, comprising:
a first filter having a first frequency range and coupled between said first and third ports for applying a first transfer function to a first radio frequency signal from said first port to said third port;
a second filter having a second frequency range and coupled between said second and said third ports for applying a second transfer function to a second RF signal from said third port to said second port;
a switch being configured to be set in least a first and a second position according to a control signal for selecting a first or a second configuration mode of said multiplexing filter;
a third filter having a third frequency range in between said first and said second frequency range, said third filter being configured to be coupled, when said switch is in said first position, between said third port and said second port, thereby extending the first frequency range with the second frequency range through overlapping roll-off regions of said first filter and said third filter, and when said switch is in said second position, between said first port and said third port, thereby extending the third frequency range with the second frequency range through overlapping roll-off regions of said third filter and said second filter.

14. The receiver comprising a multiplexing filter according to claim 13, wherein said first configuration mode of said multiplexing filter corresponds to Data Over Cable Service Interface Specification 3.1 and said second configuration mode of said multiplexing filter corresponds to Data Over Cable Service Interface Specification 3.0.

15. The receiver comprising a multiplexing filter according to claim 14, wherein said multiplexing filter comprises a diplexer filter, said third port comprises a cable connector for connecting said cable connector to a transmission line that may be coupled to a cable provider, said first port is an upstream port and said second port is a downstream port.

16. The receiver comprising a multiplexing filter according to claim 13, further comprising a first delay network coupled in series with at least one of said first and second filters for matching a propagation delay via said third filter and a propagation delay via said at least one of said first and second filters.

17. The receiver comprising a multiplexing filter according to claim 16, further comprising a second delay network coupled in series with the other one of said first and second filters for matching a propagation delay via said third filter and via said other one of said first and second filters.
